(19) United States
(12) Patent Application Publication
(10) Pub. No.: US 2017/0249854 A1
(43) Pub. Date: Aug. 31, 2017

(54) SYSTEMS AND METHODS FOR VIRTUAL LEARNING ENVIRONMENTS

(71) Applicant: Baylor Research Institute, Dallas, TX (US)

(72) Inventors: William August HITES, Dallas, TX (US); Mathew Alexander FEDOROVICH, Dallas, TX (US); Dora BRADLEY, Dallas, TX (US)

(21) Appl. No.: 15/502,426

(22) PCT Filed: Aug. 7, 2015
(86) PCT No.: PCT/US15/44265

§ 371 Date: Feb. 7, 2017

Related U.S. Application Data
(60) Provisional application No. 62/034,884, filed on Aug. 8, 2014.

(51) Int. Cl. G09B 9/00; G09B 7/04; G09B 5/06; G09B 19/00

(52) U.S. Cl. CPC G09B 9/00; G09B 19/00; G09B 7/04; G09B 5/065

(57) ABSTRACT

Systems and methods for virtual learning environments, such as those, for example, configured to assist in evaluating a user, including the competency of a user, in a field of interest.

This application claims the benefit of priority to U.S. Provisional Patent Application Ser. No. 62/034,884, filed Aug. 8, 2014, hereby incorporated by reference in its entirety.

### BACKGROUND OF THE INVENTION

1. Field of the Invention

This invention generally relates to virtual learning environments, and more particularly, but not by way of limitation, to systems and methods for virtual learning environments, such as those, for example, configured to assist in evaluating a user, including the competency of a user, in a field of interest.

2. Description of the Related Art

An example of a virtual learning environment is disclosed in U.S. Patent Publication No. 2013/0244218.

### SUMMARY OF THE INVENTION

Some embodiments of the present methods (e.g., of evaluating a user of a virtual learning environment) comprise: presenting a user with a first scenario in a virtual learning environment; permitting the user to make one or more selections in response to a plurality of assessments in the first scenario; identifying a value, if any, corresponding to the one or more user selections; using at least one of the one or more user selections and the corresponding values, if any, to determine a second scenario; presenting the user with the second scenario; and permitting the user to make one or more selections in response to a plurality of assessments in the second scenario. In some embodiments, the second scenario is determined in part by an algorithm. In some embodiments, the input to the algorithm comprises the values corresponding to the one or more user selections, if any, and the output of the algorithm comprises one of a plurality of levels relating to user competency. In some embodiments, the levels relating to user competency are based on a standard of care. In some embodiments, using at least one of the one or more user selections and the corresponding values, if any, to determine a second scenario comprises summing the corresponding values to determine the second scenario. In some embodiments, the plurality of assessments in the second scenario are substantially similar to the plurality of assessments in the first scenario. In some embodiments, the values corresponding to the one or more user selections in the second scenario, if any, are different than the values corresponding to the one or more user selections in the first scenario, if any. In some embodiments, the values corresponding to the one or more user selections, if any, are based on the user selection and the number of attempts to make the user selection. In some embodiments, at least one of the one or more user selections in the second scenario is different than at least one of the one or more user selections in the first scenario. Some embodiments further comprise permitting an administrator to manipulate at least a portion of the virtual learning environment. In some embodiments, the administrator can manipulate a value corresponding to the one or more user selections, if any. In some embodiments, the administrator can select the first scenario presented to the user. In some embodiments, the administrator can customize the first scenario presented to the user. Some embodiments further comprise preparing a report based on the one or more user selections. In some embodiments, the report comprises information relating to at least one of the one or more user selections, information relating to a standard of care, and information relating to deviation of the one or more user selections from the standard of care. In some embodiments, at least a portion of the first scenario changes based on the one or more user selections during the first scenario. Some embodiments further comprise presenting a lesson to the user relating to the first scenario.

Some embodiments of the present methods (e.g., of determining user competency in a virtual learning environment) comprise presenting a user with a plurality of assessments in a first scenario in a virtual learning environment; permitting the user to respond to each of the plurality of assessments; identifying a value corresponding to each user response to the plurality of assessments, if any; and determining, with an algorithm, a user competency level. Some embodiments further comprise presenting a second scenario of a plurality of scenarios to the user based on the user competency level. Some embodiments further comprise permitting the user to select from a plurality of user selections to respond to at least some of the plurality of assessments. In some embodiments, each of the plurality of assessments are presented sequentially. In some embodiments, a subsequent assessment in the plurality of assessments changes based on a user response to a prior assessment in the plurality of assessments. In some embodiments, the input to the algorithm comprises the values corresponding to each user response to the plurality of assessments, if any, and the output of the algorithm comprises one of a plurality of levels relating to user competency. In some embodiments, the levels relating to user competency are based on a standard of care. In some embodiments, the algorithm includes summing the values corresponding to each user response to the plurality of assessments, if any. In some embodiments, the second scenario comprises a plurality of assessments, and the plurality of assessments in the second scenario are substantially similar to the plurality of assessments in the first scenario. In some embodiments, the values corresponding to each user response to the plurality of assessments in the second scenario, if any, are different than the values corresponding to each user response to the plurality of assessments in the first scenario, if any. In some embodiments, the values corresponding to each user response to the plurality of assessments in the first scenario, if any, are based on the user response and the number of attempts to make the user response. In some embodiments, the values corresponding to each user response to the plurality of assessments in the second scenario, if any, are based on the user response and the number of attempts to make the user response. Some embodiments further comprise permitting an administrator to manipulate at least a portion of the virtual learning environment. In some embodiments, the administrator can manipulate a value corresponding to each user response to the plurality of assessments, if any. In some embodiments, the administrator can select the first scenario presented to the user. In some embodiments, the administrator can customize the first scenario presented to the user. Some embodiments further comprise preparing a report based on the user responses to the plurality of assessments. In some embodiments, the report comprises information relating to at least one of the user responses, information relating to a standard of care, and information relating to deviation of the user responses from the standard of care. In some embodiments, at least a portion of the first scenario changes based on the user responses to the plurality of assessments during the first scenario. Some embodiments further comprise presenting a lesson to the user relating to the first scenario.

Some embodiments of the present systems comprise one or more processors; and one or more non-transitory machine-readable storage media with instructions executable by the one or more processors and configured to cause the one or more processors to: present a user with a first scenario in a virtual learning environment; permit the user to make one or more selections in response to a plurality of assessments in the first scenario; identify a value, if any, corresponding to the one or more user selections; use at least one of the one or more user selections and the corresponding values, if any, to determine a second scenario; present the user with the second scenario; and permit the user to make one or more selections in response to a plurality of assessments in the second scenario. In some embodiments, the second scenario is determined in part by an algorithm. In some embodiments, the input to the algorithm comprises the values corresponding to the one or more user selections, if any, and the output of the algorithm comprises one of a plurality of levels relating to user competency. In some embodiments, the levels relating to user competency are based on a standard of care. In some embodiments, to use at least one of the one or more user selections and the corresponding values, if any, to determine a second scenario comprises summing the corresponding values to determine the second scenario. In some embodiments, the plurality of assessments in the second scenario are substantially similar to the plurality of assessments in the first scenario. In some embodiments, the values corresponding to the one or more user selections in the second scenario, if any, are different than the values corresponding to the one or more user selections in the first scenario, if any. In some embodiments, the values corresponding to the one or more user selections, if any, are based on the user selection and the number of attempts to make the user selection. In some embodiments, at least one of the one or more user selections in the second scenario is different than at least one of the one or more user selections in the first scenario. In some embodiments, the one or more non-transitory machine-readable storage media are further configured to cause the one or more processors to permit an administrator to manipulate at least a portion of the virtual learning environment. In some embodiments, the administrator can manipulate a value corresponding to the one or more user selections, if any. In some embodiments, the administrator can select the first scenario presented to the user. In some embodiments, the administrator can customize the first scenario presented to the user. In some embodiments, the one or more non-transitory machine-readable storage media are further configured to cause the one or more processors to prepare a report based on the one or more user selections. In some embodiments, the report comprises information relating to at least one of the one or more user selections, information relating to a standard of care, and information relating to deviation of the one or more user selections from the standard of care. In some embodiments, at least a portion of the first scenario changes based on the one or more user selections during the first scenario. In some embodiments, the one or more non-transitory machine-readable storage media are further configured to cause the one or more processors to present a lesson to the user relating to the first scenario.

Some embodiments of the present systems comprise one or more processors; and one or more non-transitory machine-readable storage media with instructions executable by the one or more processors and configured to cause the one or more processors to: present a user with a plurality of assessments in a first scenario in a virtual learning environment; permit the user to respond to each of the plurality of assessments; identify a value corresponding to each user response to the plurality of assessments, if any; and determine, with an algorithm, a user competency level. In some embodiments, the one or more non-transitory machine-readable storage media are further configured to cause the one or more processors to present a second scenario of a plurality of scenarios to the user based on the user competency level. In some embodiments, the one or more non-transitory machine-readable storage media are further configured to cause the one or more processors to permit the user to select from a plurality of user selections to respond to at least some of the plurality of assessments. In some embodiments, each of the plurality of assessments are presented sequentially. In some embodiments, a subsequent assessment in the plurality of assessments changes based on a user response to a prior assessment in the plurality of assessments. In some embodiments, the input to the algorithm comprises the values corresponding to each user response to the plurality of assessments, if any, and the output of the algorithm comprises one of a plurality of levels relating to user competency. In some embodiments, the levels relating to user competency are based on a standard of care. In some embodiments, the algorithm includes summing the values corresponding to each user response to the plurality of assessments, if any. In some embodiments, the second scenario comprises a plurality of assessments, and the plurality of assessments in the second scenario are substantially similar to the plurality of assessments in the first scenario. In some embodiments, the values corresponding to each user response to the plurality of assessments in the second scenario, if any, are different than the values corresponding to each user response to the plurality of assessments in the first scenario, if any. In some embodiments, the values corresponding to each user response to the plurality of assessments in the first scenario, if any, are based on the user response and the number of attempts to make the user response. In some embodiments, the values corresponding to each user response to the plurality of assessments in the second scenario, if any, are based on the user response and the number of attempts to make the user response. In some embodiments, the one or more non-transitory machine-readable storage media are further configured to cause the one or more processors to permit an administrator to manipulate at least a portion of the virtual learning environment. In some embodiments, the administrator can manipulate a value corresponding to each user response to the plurality of assessments, if any. In some embodiments, the administrator can select the first scenario presented to the user. In some embodiments, the administrator can customize the first scenario presented to the user. In some embodiments, the one or more non-transitory machine-readable storage media are further configured to cause the one or more processors to prepare a report based on the user responses to the plurality of assessments. In some embodiments, the report comprises information relating to at least one of the user responses, information relating to a standard of care, and information relating to deviation of the user responses from the standard of care. In some embodiments, the first scenario changes based on the user responses to the plurality of assessments during the first scenario. In some embodiments, the one or more non-transitory machine-readable storage media are further configured to cause the one or more processors to present a lesson to the user relating to the first scenario.

Some embodiments of the present non-transitory machine-readable storage medium with instructions executable by a processor of a computing device comprise instructions for presenting a user with a first scenario in a virtual learning environment; instructions for permitting the user to make one or more selections in response to a plurality of assessments in the first scenario; instructions for identifying a value, if any, corresponding to the one or more user selections; instructions for using at least one of the one or more user selections and the corresponding values, if any, to determine a second scenario; instructions for presenting the user with the second scenario; and instructions for permitting the user to make one or more selections in response to a plurality of assessments in the second scenario. In some embodiments, the second scenario is determined in part by an algorithm. In some embodiments, the input to the algorithm comprises the values corresponding to the one or more user selections, if any, and the output of the algorithm comprises one of a plurality of levels relating to user competency. In some embodiments, the levels relating to user competency are based on a standard of care. In some embodiments, the instructions for using at least one of the one or more user selections and the corresponding values, if any, to determine a second scenario comprises summing the corresponding values to determine the second scenario. In some embodiments, the plurality of assessments in the second scenario are substantially similar to the plurality of assessments in the first scenario. In some embodiments, the values corresponding to the one or more user selections in the second scenario, if any, are different than the values corresponding to the one or more user selections in the first scenario, if any. In some embodiments, the values corresponding to the one or more user selections, if any, are based on the user selection and the number of attempts to make the user selection. In some embodiments, at least one of the one or more user selections in the second scenario is different than at least one of the one or more user selections in the first scenario. Some embodiments further comprise instructions for permitting an administrator to manipulate at least a portion of the virtual learning environment. In some embodiments, the administrator can manipulate a value corresponding to the one or more user selections, if any. In some embodiments, the administrator can select the first scenario presented to the user. In some embodiments, the administrator can customize the first scenario presented to the user. Some embodiments further comprise instructions for preparing a report based on the one or more user selections. In some embodiments, the report comprises information relating to at least one of the one or more user selections, information relating to a standard of care, and information relating to deviation of the one or more user selections from the standard of care. In some embodiments, at least a portion of the first scenario changes based on the one or more user selections during the first scenario. Some embodiments further comprise instructions for presenting a lesson to the user relating to the first scenario.

Some embodiments of the present non-transitory machine-readable storage medium with instructions executable by a processor of a computing device comprise instructions for presenting a user with a plurality of assessments in a first scenario in a virtual learning environment; instructions for permitting the user to respond to each of the plurality of assessments; instructions for identifying a value corresponding to each user response to the plurality of assessments, if any; and instructions for determining, with an algorithm, a user competency level. Some embodiments further comprise instructions for presenting a second scenario of a plurality of scenarios to the user based on the user competency level. Some embodiments further comprise instructions for permitting the user to select from a plurality of user selections to respond to at least some of the plurality of assessments. In some embodiments, each of the plurality of assessments are presented sequentially. In some embodiments, a subsequent assessment in the plurality of assessments changes based on a user response to a prior assessment in the plurality of assessments. In some embodiments, the input to the algorithm comprises the values corresponding to each user response to the plurality of assessments, if any, and the output of the algorithm comprises one of a plurality of levels relating to user competency. In some embodiments, the levels relating to user competency are based on a standard of care. In some embodiments, the algorithm includes summing the values corresponding to each user response to the plurality of assessments, if any. In some embodiments, the second scenario comprises a plurality of assessments, and the plurality of assessments in the second scenario are substantially similar to the plurality of assessments in the first scenario. In some embodiments, the values corresponding to each user response to the plurality of assessments in the second scenario, if any, are different than the values corresponding to each user response to the plurality of assessments in the first scenario, if any. In some embodiments, the values corresponding to each user response to the plurality of assessments in the first scenario, if any, are based on the user response and the number of attempts to make the user response. In some embodiments, the values corresponding to each user response to the plurality of assessments in the second scenario, if any, are based on the user response and the number of attempts to make the user response. Some embodiments further comprise instructions for permitting an administrator to manipulate at least a portion of the virtual learning environment. In some embodiments, the administrator can manipulate a value corresponding to each user response to the plurality of assessments, if any. In some embodiments, the administrator can select the first scenario presented to the user. In some embodiments, the administrator can customize the first scenario presented to the user. Some embodiments further comprise instructions for preparing a report based on the user responses to the plurality of assessments. In some embodiments, the report comprises information relating to at least one of the user responses, information relating to a standard of care, and information relating to deviation of the user responses from the standard of care. In some embodiments, at least a portion of the first scenario changes based on the user responses to the plurality of assessments during the first scenario. Some embodiments further comprise instructions for presenting a lesson to the user relating to the first scenario.

The terms “coupled” and “interface” are defined as connected, although not necessarily directly, and not necessarily mechanically or electrically. Two items are “couplable” or “interfaceable” if they can be coupled to or interfaced with each other. Unless the context explicitly requires otherwise, items that are couplable are also decouplable and items that are interfaceable are deinterfaceable, and vice-versa. One non-limiting way in which a first structure is couplable or interfaceable to a second structure is for the first structure to be configured to be coupled to or configured to be interfaced with the second structure.

The terms “a” and “an” are defined as one or more unless this disclosure explicitly requires otherwise.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, or a component of a system or a storage medium, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

The term “determine” (and any form of determine, such as “determines,” “determined,” and “determining”) is used broadly throughout this disclosure to include the receiving or gathering of information and any resulting calculations with and/or manipulations of such information and should include terms (and derivatives of such terms) such as detecting, measuring, identifying, receiving, and similar terms.

Any embodiment of any of the systems, storage media, and methods can consist of or consist essentially of—rather than comprise/include/contain/have—any of the described elements, features, and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. At least some of the figures illustrate the described elements using graphical symbols that will be understood by those of ordinary skill in the art.

FIG. 1 depicts one embodiment of a system on which applications relating to the present virtual learning environments can run.

FIG. 2 depicts a flow diagram of one embodiment of the present methods, which can take place using the present systems.

FIG. 3 depicts a flow diagram of one embodiment of at least a portion of an application that can carry out operations relating to the present virtual learning environments.

FIGS. 3A-3D each depicts a portion of the flow diagram of FIG. 3.

FIG. 4 depicts a flow diagram of examples of assessments and user responses/selections that can be presented in a scenario of the present virtual learning environments.

FIGS. 4A depicts a segmented version of a portion of the flow diagram of FIG. 4.

FIGS. 4B depicts a segmented version of a portion of the flow diagram of FIG. 4.

FIGS. 4C depicts a portion of the flow diagram of FIG. 4.

FIGS. 4D depicts a portion of the flow diagram of FIG. 4.

FIG. 5 depicts a flow diagram of examples of assessments and user responses/selections that can be presented in a scenario of the present virtual learning environments.

FIG. 6 depicts a flow diagram of examples of assessments and user responses/selections that can be presented in a scenario of the present virtual learning environments.

FIG. 6A depicts a segmented version of the flow diagram of FIG. 6.

FIG. 7 depicts a flow diagram of examples of assessments and user responses/selections that can be presented in a scenario of the present virtual learning environments.

FIG. 7A depicts a segmented version of the flow diagram of FIG. 7.

FIG. 8 depicts one example of a display relating to a scenario of the present virtual learning environments, which depicts, for example, various assessments.

FIG. 9 depicts one example of a record that can be created relating to a scenario of the present virtual learning environments.

FIGS. 10-11 each depicts an example of a display in a scenario of the present virtual learning environments.

### DESCRIPTION OF ILLUSTRATIVE EMBODIMENTS

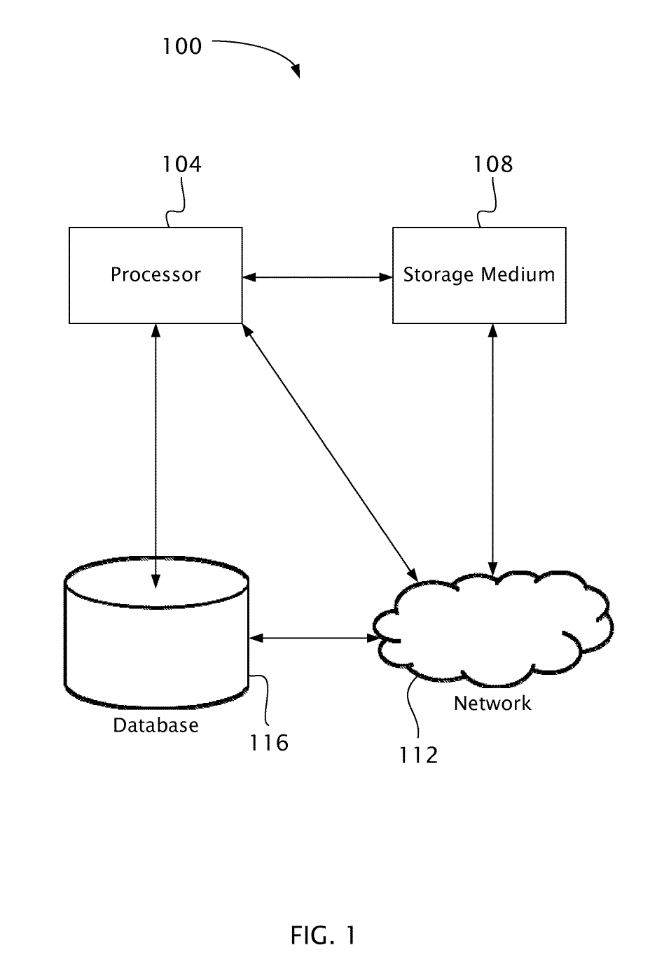

Referring now to FIG. 1, designated by numeral 100 is one embodiment of the present systems. System 100 comprises one or more processors 104 and one or more storage media 108, which includes non-transitory computer-/machine-readable storage media. One or more storage media 108 comprise instructions executable by one or more processors 104 and are configured to cause one or more processors 108 to perform a variety of operations. The systems described in this disclosure will be understood to comprise computer systems, and the functions described in this disclosure may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

The systems of the present disclosure will be understood to include any electronic device configured or configurable to perform the operations described in this disclosure, such as a personal computing device, a laptop computing device, a tablet computing device, a smartphone, and the like. Such systems can include and/or be coupled to input/output (“I/O”) devices, such as a printer, a mouse, a keyboard, a touchscreen display device, a scanner, a numeric keypad, and combinations thereof. A communication interface can be configured to communicatively couple the electronic device to one or more networks, such as via a wired or wireless connection established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3rd Generation (3G) protocol, a 4th Generation (4G)/long term evolution (LTE) protocol, and the like).

The steps of methods or algorithms described in this disclosure may be embodied directly in hardware (e.g., circuitry), in programmable circuitry appropriately programmed with software and/or firmware, such as in a software module executed by a processor, or in a combination of the two. A software module may reside in random access memory (RAM), flash memory, read only memory (ROM), erasable programmable read only memory (EPROM), electrically erasable programmable read only memory (EEPROM), magneto-resistive random access memory (MRAM), registers, cache memory, optical memory, hard disk, a removable disk, solid state drives (SSDs), or any other form of storage medium known in the art, such as any memory device configured to store data in a persistent or non-persistent state, or a combination thereof. An exemplary storage medium is coupled to a processor such that the processor can read information from, and write information to, the storage medium. For example, in the embodiment shown, one or more storage media 108 can be coupled to and/or in communication with one or more processors 104 via network 112 such that one or more storage media 108 are in communication with one or more processors 104 but are not physically coupled to one or more processors 104. Network 112 may be a wired network, a wireless network, or may include a combination of wired and wireless networks. For example, network 112 may be a local area network (LAN), a wide area network (WAN), a wireless WAN, a wireless LAN (WLAN), a metropolitan area network (MAN), a wireless MAN network, a cellular data network, a cellular voice network, the internet, and/or a combination thereof. In other embodiments, one or more storage media 108 may be physically coupled to one or more processors 104 and/or may be integral to one or more processors 104. A processor and a storage medium may reside in an ASIC. The ASIC may reside in a user terminal. In the some embodiments, a processor and a storage medium may reside as discrete components in a user terminal.

In one or more exemplary designs, the functions described may be implemented in hardware, software, firmware, or any combination thereof. If implemented in software, the functions may be stored as one or more instructions or code on a non-transitory computer-/machine-readable storage medium. A storage media may be any available media that can be accessed by a general-purpose or special-purpose computer or processor. By way of example, and not limitation, such computer-readable media can comprise random access memory (RAM), flash memory, read only memory (ROM), erasable programmable read only memory (EPROM), electrically erasable programmable read only memory (EEPROM), magneto-resistive random access memory (MRAM), registers, cache memory, optical memory, hard disk, a removable disk, solid state drives (SSDs), or any other form of storage medium known in the art, such as any memory device configured to store data in a persistent or non-persistent state, or any other medium that can be used to carry or store desired program code means in the form of instructions or data structures and that can be accessed by a general-purpose or special-purpose computer, or a general-purpose or special-purpose processor, and combinations thereof. Such media can include, disks or discs, such as includes compact disc (CD), re-writable CDs, laser disc, optical disc, digital video disc or digital versatile disc (DVD), re-writable DVDs, floppy disk, and blu-ray disc. Combinations of the above should also be included within the scope of non-transitory computer-/machine-readable media.

In the embodiment shown in FIG. 1, one or more processors 104 are coupled to database 116. One or more processors 104 can be physically coupled to database 116 or wirelessly coupled to database 116. Database 116 can comprise one or more databases that are configured to store information in system 100 such that the information can be sent to and/or retrieved by one or more processors 104.

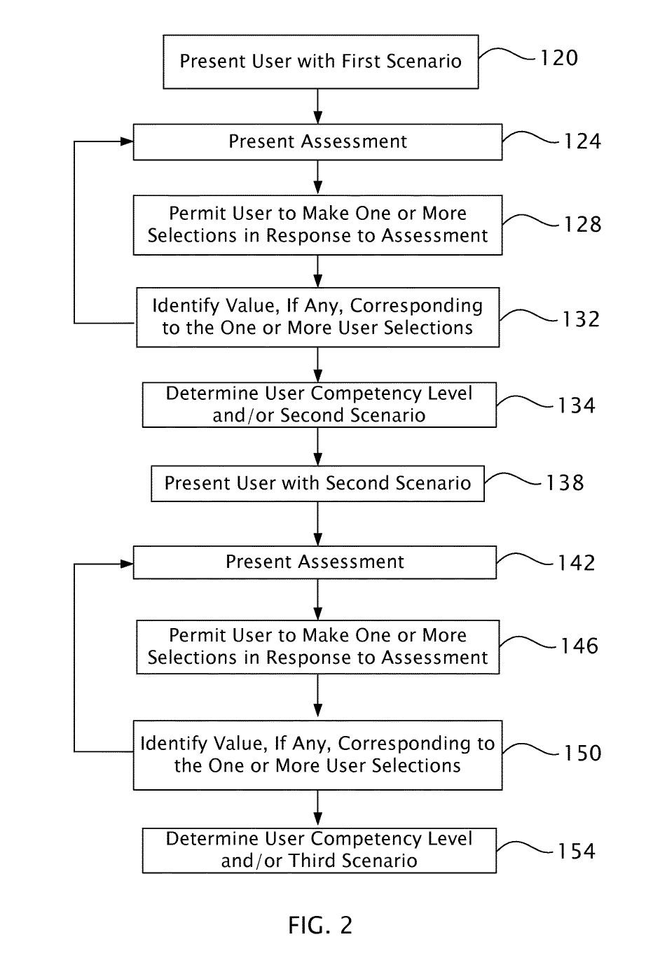

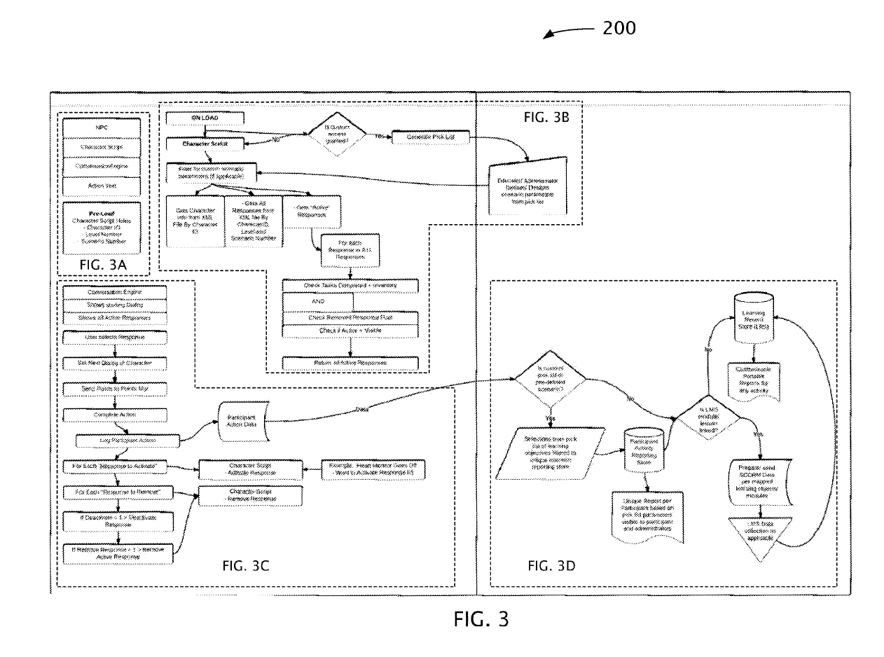

As depicted in the embodiment shown in FIG. 2, the present systems can be configured such that one or more storage media are configured to cause (e.g., by comprising instructions) one or more processors to present a user with a scenario in a virtual learning environment (e.g., block 120). A virtual learning environment can relate to any number of fields of interest in which a user is being evaluated, such as, for example, health care, computers, legal, financial, military, and any other fields. A scenario in a virtual learning environment can relate to any number of circumstances with which an individual in a given field of interest may be presented and/or over which an individual in a given field may be evaluated. The virtual learning environments and corresponding scenarios can be configured (e.g., programmed and/or manipulated) to relate to any field, any area within of a given field, and any position or role that an individual may have within a given field and/or be evaluated over.

As depicted in the embodiment shown in FIG. 2, one or more storage media of the present disclosure can also be configured to cause (e.g., by comprising instructions) one or more processors to present a plurality of assessments to a user (e.g., block 124), including sequentially or simultaneously, and to permit a user to respond (e.g., by making one or more selections) to a plurality of assessments in a first scenario (e.g., block 128). For example, some assessments can permit a user to respond by making one selection, declining to make the one selection, or failing to make the one selection. Other assessments can permit a user to respond by making one selection from a plurality of selections declining to make one selection from a plurality of selections, or failing to make one selection from a plurality of selections. Still other assessments can permit a user to respond by making more than one selection from a plurality of selections.

As shown in FIG. 2, one or more storage media of the present disclosure can further be configured to cause (e.g., by comprising instructions) one or more processors to identify a value, if any, corresponding to each user response, such as to the one or more user selections (e.g., block 132). The values of the present disclosure include numerical values. In some embodiments, each user response or selection has a value corresponding to it, and in other embodiments, only a portion of the user responses or selections have a value corresponding to them. In some embodiments, the values corresponding to each user response, such as one or more user selections, if any, are based on the user response or selection and/or the number of attempts to make the user response or selection. For example, a user response or selection may receive a first value if the user takes one attempt to make the user response or selection, a user response or selection may receive a second value if the user takes two attempts to make the user response or selection, a user response or selection may receive a third value if the user takes three attempts to make the user response or selection, and so forth. Each of the values (e.g., the first value, the second value, and the third value) may comprise the same numerical value or different numerical values depending on the circumstances. In some embodiments, a value corresponding to a user response or selection and a value corresponding to the number of attempts to make the user response or selection are embodied as separate values, and in other embodiments, they are embodied as the same value.

In some embodiments, a scenario in a virtual learning environment can change (either within the same scenario or in a subsequent scenario) based on a user response or selection in the scenario and/or the number of attempts to make the user response or selection in the scenario. For example, in some embodiments one or more subsequent assessments can change based on one or more prior user responses or selections and/or the number of attempts to make the one or more prior user responses or selections. As another example, one or more of the subsequent user responses or selections available for selection can change based on one or more prior user responses or selections and/or the number of attempts to make the one or more prior user responses or selections. A change in subsequent assessments and/or subsequent available user responses or selections in a given scenario can be based on a number of factors, such as, for example, one or more of the values corresponding to the one or more user responses or selections, number of attempts to make the one or more user responses or selections, the sum of the values corresponding to the one or more user responses or selections and the number of attempts to make the one or more user responses or selections, some other algorithm that takes into account the values corresponding to the one or more user responses or selections and the number of attempts to make the one or more user responses or selections, a user competency level (e.g., determined by the system, such as by an algorithm that receives values corresponding to one or more user responses or selections as inputs), an administrator (e.g., prior to commencement of the scenario or during the scenario), and the like.

As depicted in the embodiment shown in FIG. 2, one or more storage media of the present disclosure can also be configured to cause (e.g., by comprising instructions) one or more processors to use at least one of the one or more user responses or selections, the number of attempts to make the one or more user responses or selections, the values corresponding to the one or more user responses or selections, if any, and the values corresponding to the number of attempts to make the one or more user responses or selections, if any, to determine a user competency level and/or a second scenario (e.g., block 134). For example, in some embodiments, the user competency level and/or the second scenario can be determined in part by an algorithm, such as, for example, by an algorithm that sums the values corresponding to the one or more user responses or selections and/or the values corresponding to the number of attempts to make the one or more user responses or selections, if any. In one embodiment, the input to such an algorithm comprises the values corresponding to the one or more user responses or selections, if any, and/or the values corresponding to the number of attempts to make the one or more user responses or selections, if any. In some embodiments, the algorithm can further be configured to output a score and/or one of a plurality of levels (e.g., low, medium, and high) that relates to user competency. In some embodiments, the algorithm can be configured to output a suggested second scenario, which can be, for example, related to a user competency level (e.g., based on a user's performance in the first scenario). A user competency or a user competency level for a given virtual learning environment or a given scenario can be based on (or relate to) a standard of care or clinical guidelines (e.g., a standard of care or clinical guidelines for assessing/evaluating a patient with heart failure), which can be established within a practice group, within an institution, or by a third-party entity, such that a user can be evaluated with respect to or in comparison to that standard of care or clinical guidelines.

As depicted in the embodiment shown in FIG. 2 and similarly to that described above, one or more storage media of the present disclosure can also be configured to cause (e.g., by comprising instructions) one or more processors, to present the user with a second scenario (e.g., block 138), present the user with a plurality of assessments (e.g., block 142), permit the user to respond to each of the plurality of assessments, such as by making one or more selections in response to the plurality of assessments (e.g., block 146), identify a value, if any, corresponding to the user responses or selections (e.g., block 150), and determine a user competency level and/or a third scenario (e.g., block 154). Blocks 138, 142, 146, 150, and 154 can be similar in characteristics and functionality to blocks 120, 124, 128, 132, and 134, but are not required to be. For example, the plurality of assessments in the second scenario can be the same as, similar to, or different from the plurality of assessments in the first scenario. As another example, responses or selections available to a user in the second scenario can be the same as, similar to, or different from the responses or selections available to a user in the first scenario. As a further example, the values corresponding to user responses, such as one or more user selections, if any, and/or a value corresponding to a number of attempts to make a response, such as the one or more user selections, if any, in the second scenario, can be the same as, similar to, or different from the values corresponding to user responses, such as the one or more user selections, if any, and/or a value corresponding to a number of attempts to make a response, such as the one or more user selections, if any, in the first scenario.

In some embodiments, the one or more storage media are further configured to cause (e.g., by comprising instructions) one or more processors to permit an administrator to select, manipulate, and/or customize at least a portion of the virtual learning environments. For example, an administrator can select a virtual learning environment, a scenario within a virtual learning environment, and/or a position or role in which a user of the virtual learning environment will be evaluated. Further, an administrator can select and/or manipulate the plurality of assessments, user responses or selections, the values corresponding to a user response or selection (if any), and the values corresponding to the number of attempts to make a response or selection (if any).

In some embodiments, the one the one or more storage media are further configured to cause (e.g., by comprising instructions) one or more processors to prepare a report based on a user response (e.g., one or more user selections). The report can comprise any information (or manipulations/calculations of such information) relating to a virtual learning environment, such as, for example, information relating to a user, information relating to one or more scenarios, information relating to a user response or selection, information relating to the values (or sum thereof) corresponding to a user response or selection, information relating to the values (or sum thereof) corresponding to the number of attempts to make a user response or selection, information relating to a standard of care, information relating to deviation of a user response or selection (or corresponding values) from a standard of care, and information relating to deviation of the number of attempts to make a user response or selection (or corresponding values) from the standard of care.

In some embodiments, the one or more storage media are further configured to cause (e.g., by comprising instructions) one or more processors to present a lesson to a user. For example, the lesson can be educational and can relate a virtual learning environment, such as to one or more of the scenarios in a virtual learning environment and the assessments, responses, and user selections that form a part of the one or more scenarios. A lesson can be presented to a user at any time, such as prior to a first scenario, between a first scenario and a second scenario, between a second scenario and a third scenario, prior to exiting the virtual learning environment, and so forth.

The present disclosure also includes methods, including, for example, methods of evaluating a user of a virtual learning environment. Such methods can comprise presenting a user with a first scenario in a virtual learning environment (e.g., block 120); permitting the user to make one or more selections in response to a plurality of assessments in the first scenario (e.g., block 128); identifying a value, if any, corresponding to the one or more user selections (e.g., block 132); using at least one of the one or more user selections and the corresponding values, if any, to determine a second scenario (e.g., block 134); presenting the user with the second scenario (e.g., block 138); and permitting the user to make one or more selections in response to a plurality of assessments in the second scenario (e.g., block 146). In some embodiments, the second scenario is determined in part by an algorithm. In some embodiments, the input to the algorithm comprises the values corresponding to the one or more user selections, if any, and the output of the algorithm comprises one of a plurality of levels relating to user competency. In some embodiments, the levels relating to user competency are based on a standard of care. In some embodiments, using at least one of the one or more user selections and the corresponding values, if any, to determine a second scenario comprises summing the corresponding values to determine the second scenario. In some embodiments, the plurality of assessments in the second scenario are substantially similar to the plurality of assessments in the first scenario. In some embodiments, the values corresponding to the one or more user selections in the second scenario, if any, are different than the values corresponding to the one or more user selections in the first scenario, if any. In some embodiments, the values corresponding to the one or more user selections, if any, are based on the user selection and the number of attempts to make the user selection. In some embodiments, at least one of the one or more user selections in the second scenario is different than at least one of the one or more user selections in the first scenario. In some embodiments, the methods further comprise permitting an administrator to manipulate at least a portion of the virtual learning environment. In some embodiments, administrator can manipulate a value corresponding to the one or more user selections, if any. In some embodiments, the administrator can select the first scenario presented to the user. In some embodiments, the administrator can customize the first scenario presented to the user. In some embodiments, the methods further comprise preparing a report based on the one or more user selections. In some embodiments, the report comprises information relating to at least one of the one or more user selections, information relating to a standard of care, and information relating to deviation of the one or more user selections from the standard of care. In some embodiments, at least a portion of the first scenario changes based on the one or more user selections during the first scenario. In some embodiments, the methods further comprise presenting a lesson to the user relating to the first scenario.

In some embodiments, the methods include, for example, methods of determining user competency in a virtual learning environment. Such methods can include presenting a user with a plurality of assessments in a first scenario in a virtual learning environment (e.g., block 120 and 124); permitting the user to respond to each of the plurality of assessments (e.g., block 128); identifying a value corresponding to each user response to the plurality of assessments, if any (e.g., block 132); and determining, with an algorithm, a user competency level (e.g., block 134). In some embodiments, the methods further comprise presenting a second scenario of a plurality of scenarios to the user based on the user competency level (e.g., block 138). In some embodiments, the methods further comprise permitting the user to select from a plurality of user selections to respond to at least some of the plurality of assessments. In some embodiments, each of the plurality of assessments are presented sequentially. In some embodiments, a subsequent assessment in the plurality of assessments changes based on a user response to a prior assessment in the plurality of assessments. In some embodiments, the input to the algorithm comprises the values corresponding to each user response to the plurality of assessments, if any, and the output of the algorithm comprises one of a plurality of levels relating to user competency. In some embodiments, the levels relating to user competency are based on a standard of care. In some embodiments, the algorithm includes summing the values corresponding to each user response to the plurality of assessments, if any. In some embodiments, the second scenario comprises a plurality of assessments, and the plurality of assessments in the second scenario are substantially similar to the plurality of assessments in the first scenario. In some embodiments, the values corresponding to each user response to the plurality of assessments in the second scenario, if any, are different than the values corresponding to each user response to the plurality of assessments in the first scenario, if any. In some embodiments, the values corresponding to each user response to the plurality of assessments in the first scenario, if any, are based on the user response and the number of attempts to make the user response. In some embodiments, the values corresponding to each user response to the plurality of assessments in the second scenario, if any, are based on the user response and the number of attempts to make the user response. In some embodiments, the methods further comprise permitting an administrator to manipulate at least a portion of the virtual learning environment. In some embodiments, the administrator can manipulate a value corresponding to each user response to the plurality of assessments, if any. In some embodiments, the administrator can select the first scenario presented to the user. In some embodiments, the administrator can customize the first scenario presented to the user. In some embodiments, the methods further comprise preparing a report based on the user responses to the plurality of assessments. In some embodiments, the report comprises information relating to at least one of the user responses, information relating to a standard of care, and information relating to deviation of the user responses from the standard of care. In some embodiments, at least a portion of the first scenario changes based on the user responses to the plurality of assessments during the first scenario. In some embodiments, the methods further comprise presenting a lesson to the user relating to the first scenario.

### EXAMPLES

By way of example, and not limitation, the following examples are provided to illustrate the present systems and methods. Such examples relate to a virtual learning environment in the health care field, and can include lessons, scenarios, assessments, user selections, and the like relating to, for example, hypervolemia, heart failure, delirium, pressure ulcers, and any other health condition and/or health care scenario.

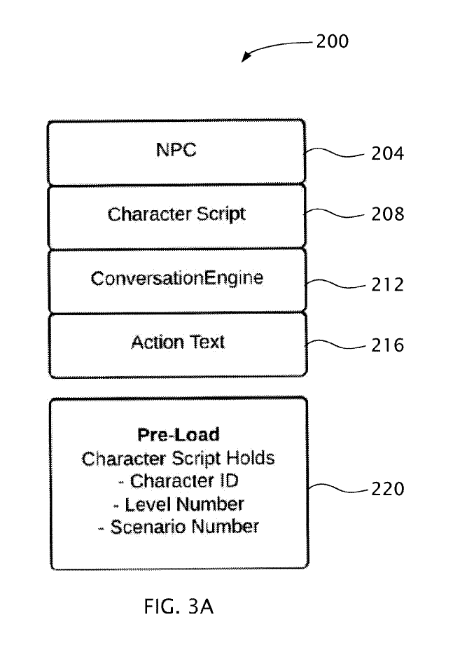

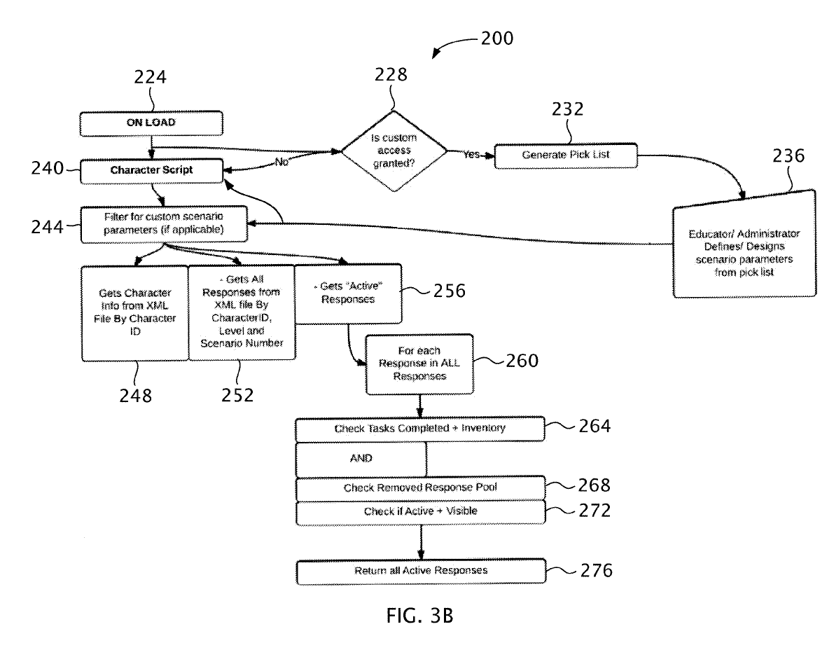

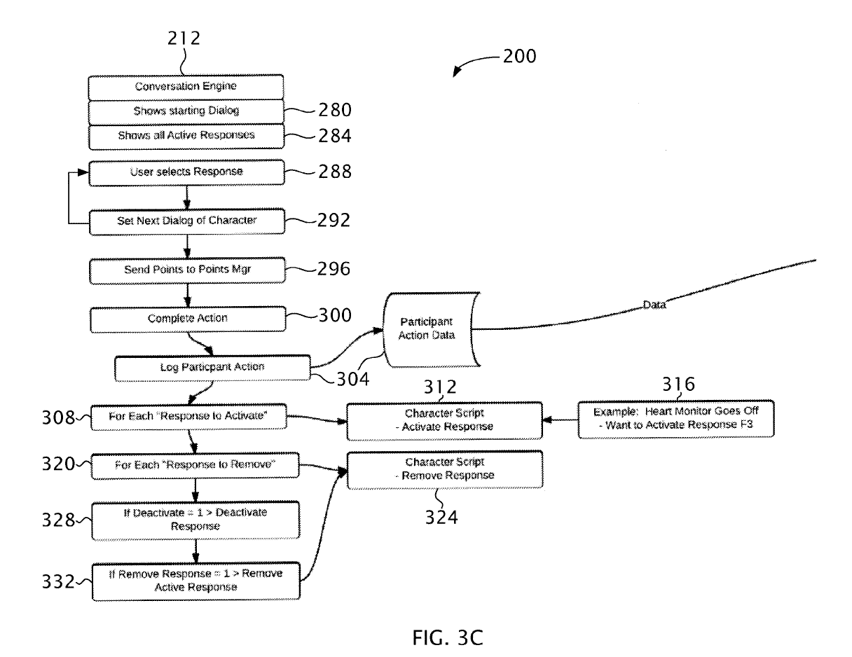

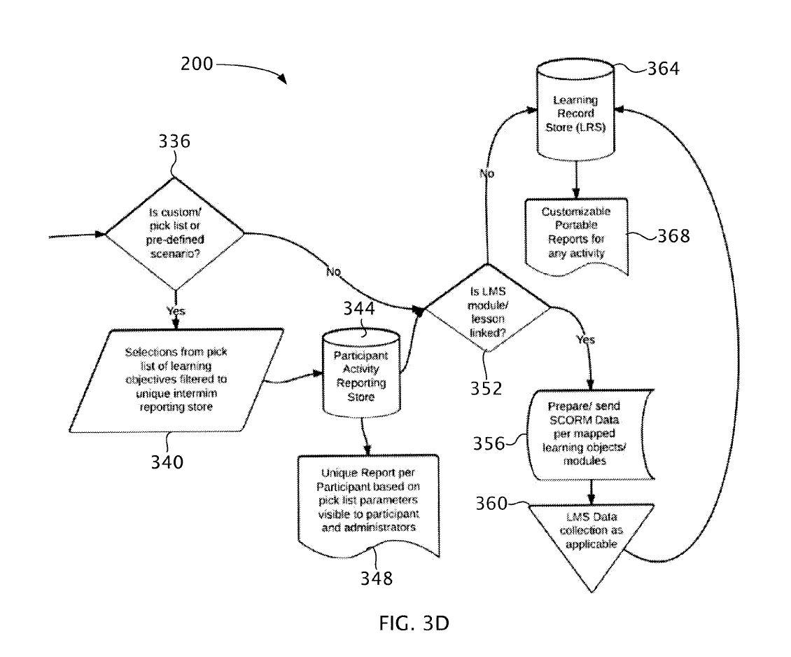

Depicted in FIG. 3, including FIGS. 3A-3D, as numeral 200 is an application that embodies one example of the present virtual learning environments. Application 200 can comprise one application or more than one application cooperating to perform the functions described. As shown more specifically in FIG. 3A, application 200 is represented by non-player character (NPC) block 204, character script block 208, conversation engine block 212, action text block 216, and pre-load block 220. Non-player character block 204 represents, for example, information relating to portions of a virtual learning environment other than the user, such as characters, which can appear or be viewed by a user and/or with which a user can interact and which are typically controlled by application 200 or the system rather than the user. For example, in some embodiments, non-player characters can suggest options/opportunities for patient care, present selections or responses to a user, provide hints to a player, and the like. Character script block 208 represents, for example, information relating to evaluation and/or level of user competency, scenarios within a virtual learning environment, such as specifics of the scenarios, assessments, user selections, the order in which scenarios and assessments progress, and the like. Character scripts can update with information relating to a patient condition as it changes, if at all, based on user selections/assessments, such as by providing patient health data, laboratory results, and the like. Conversation engine block 212, which will be discussed in detail below, represents, for example, an engine to run (or implement) the character script, including information relating to the inputs and outputs of application 200, such as user selections that can be selected, and the effect of user selections on the remainder of a scenario and/or subsequent scenarios. Action text block 216 represents, for example, information (e.g., text) that can appear to or be viewed by a user and/or with which a user can interact, including for assessments and user selections. For example, in some embodiments, action text block 216 can assist in responding to user selections by presenting (or assisting the conversation engine to present) additional user selections or responding to a user selection (e.g., such as by presenting an option to adjust a patient's fluid in response to a user selection). Pre-load block 220 indicates, for example, that during a pre-load stage, the character script can take the character/user identification, scenario number, and level number (e.g., which can relate to difficulty of a particular level) into account, including as inputs by a user and/or an administrator.

FIG. 3B depicts one example of potential operations for application 200 after a virtual learning environment is loaded. Once a virtual learning environment is loaded (e.g., on load block 224), application 200 can be configured to determine whether custom access is granted (e.g., custom access block 228), for example, to an administrator, such as by inputting a password or administrator identification number. If custom access is granted, application 200 can be configured to generate a pick list (e.g., pick list block 232), and the user to which access was granted can be permitted to manipulate and/or customize a scenario (e.g., customize parameters block 236), such as by creating parameters and/or selecting parameters from the generated pick list. Application 200 can then be configured to return to a character script (e.g., character script block 240) and/or to filter for custom scenario parameters, if applicable (e.g., filter block 244). If custom access is not granted, application 200 can be configured to proceed directly to character script (e.g., character script block 240) and to filter for custom scenario parameters, if applicable (e.g., filter block 244). Application 200 can further be configured to retrieve past information relating to a user, including by relating past information to a particular user identification name and/or number. Such past information can be used to customize, optimize, and/or affect a future scenario. For example, as shown in FIG. 3B, application 200 can be configured to retrieve information relating to a user/character (e.g., from a storage medium, such as from an XML file) based on, for example, a user/character identification (e.g., a name and/or number) (e.g., get character information block 248). Application 200 can be configured to retrieve (e.g., from a storage medium, such as from an XML file), for example, past virtual learning environments, scenarios, and assessments with which the user has been presented and any corresponding levels and past responses/selections from the user (e.g., all response block 252). Application 200 can further be configured to retrieve (e.g., from a storage medium, such as from an XML file), for example, responses/selections which a user has not been presented and/or to which a user has not responded (e.g., “active” responses) (block 256). As depicted in FIG. 3B, application 200 can be configured, for each response in all responses (e.g., each response block 260), to check completed portions of a scenario (e.g., tasks completed block 264), to check removed portions of a scenario (e.g., removed response block 268), to check if a portion of a scenario is active and/or visible (e.g., active and visible block 272), and to return all “active” responses based on such checks (e.g., return active response block 276).

FIG. 3C depicts additional examples of potential operations for application 200 after a virtual learning environment is loaded (e.g., such as operations that can occur after those described with respect to FIG. 3B). For example, application 200 (e.g., and, more specifically, conversation engine 212) can be configured to display a scenario, which can include a dialog box (e.g., dialog block 280) and potential or available responses/selections for a user (e.g., response block 284). Application 200 can further be configured to permit a user to respond, for example, to an assessment, by making one or more user selections (e.g., user response block 288). Following one or more user selections, application 200 can be configured to present another assessment (e.g., next dialog block 292), to which a user can respond by making one or more user selections. Such operations can be repeated, as depicted in FIG. 3C, depending on the virtual learning environment and/or scenario. Values corresponding to the one or more user selections, if any, can be sent to a point manager (e.g., point manager block 296). In some embodiments, point manager block 296 can assist in determining a subsequent scenario and/or subsequent assessments (e.g., by notifying the system that a point threshold has been reached or exceeded), which can include providing information relating to a user competency and/or a user competency level. Once a user response/selection is complete (e.g., complete action block 300), user responses/selections can be logged (e.g., log participant data blocks 304), which will be discussed in detail with respect to FIG. 3C. Certain user responses may be considered (e.g., or labeled as) as “response to activate” (e.g., such as a response to activate a portion of a scenario). For each user response/selection to activate (e.g., response to activate block 308), application 200 (e.g., and, more specifically, character script 208) can be configured to activate a response (e.g., activate response block 312), such as, for example, by activating a heart monitor (e.g., activate heart monitor block 316). Certain user responses may be considered (e.g., or labeled as) a “response to remove” (e.g., such as a response to remove a portion of a scenario, such as one or more assessments and/or one or more user selections). Such a response to remove can (e.g., depending on instructions from character script 208) remove and/or deactivate one or more assessments and/or one or more user selections based on occurrences in a scenario (e.g., a user selection) such that application 200 does not present the one or more assessments and/or one or more user selections again (e.g., represented by blocks 320, 324, 328, and 332).

FIG. 3D depicts additional examples of potential operations for application 200 after a virtual learning environment is loaded (e.g., such as operations that can occur before, after, or simultaneously with those described with respect to FIG. 3C). As discussed above, once a user response/selection is complete (e.g., complete action block 300), user responses/selections can be logged (e.g., log participant data blocks 304). Application 200 can be configured to determine whether the scenario is predefined or uncustomized or whether the scenario is created or customized, such as from a list of parameters selected by, for example, an administrator (e.g., determination block 336). If it is determined that a scenario was created or customized, those portions of the scenario that were created or customized (and the corresponding user responses/selections) can be filtered (e.g., filter block 340) to a separate region (e.g., participant activity reporting store block 344) for any unique values and/or scoring applied to the created or customized portion, and a report can be created based on such filtered portions (e.g., unique report block 348). Application 200 is then configured to determine whether a learning management system (LMS) module is coupled to the system/application (e.g., LMS module block 352). If it is determined that a scenario was predefined or uncustomized, application 200 can be configured to proceed directly to determining whether an LMS module is coupled to the system/application (e.g., LMS module block 352). If an LMS module is coupled to the system/application, application 200 can be configured to prepare and send data relating to the scenario, such as sharable content object reference model (SCORM) data relating to mapped learning specifications, standards, objects, and/or modules, including data relating to user responses/selections (e.g., SCORM data block 356). Such data can be prepared and sent, for example, for LMS data collection and processing (e.g., LMS data block 360) and further to a learning record store (LRS) (e.g., LRS block 364). If no LMS module is coupled to the system/application, application 200 can be configured to proceed directly to the LRS (e.g., LRS block 364). Reports can then be created and customized based on such data (e.g., report block 368).

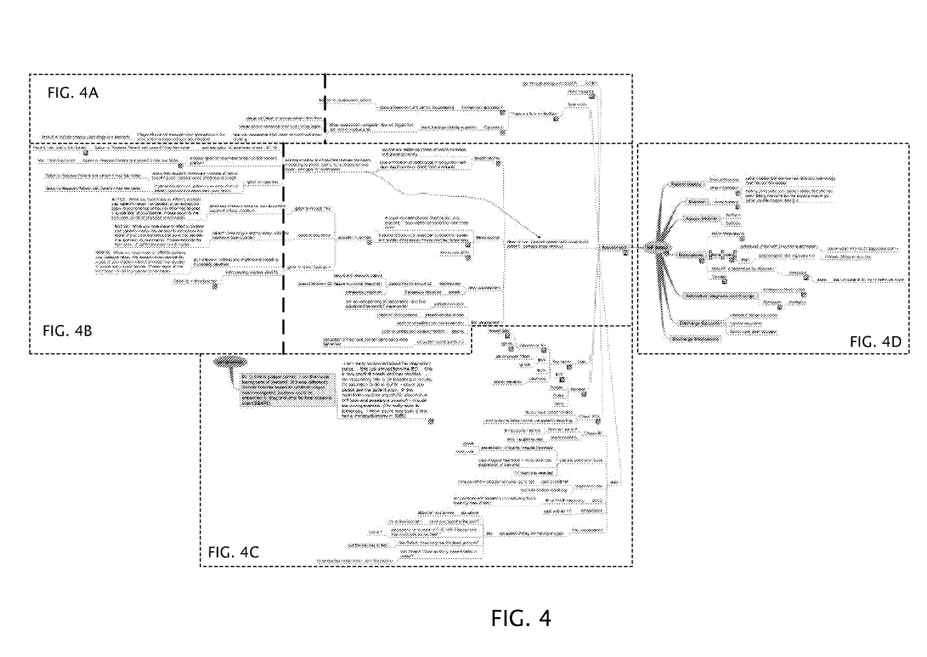

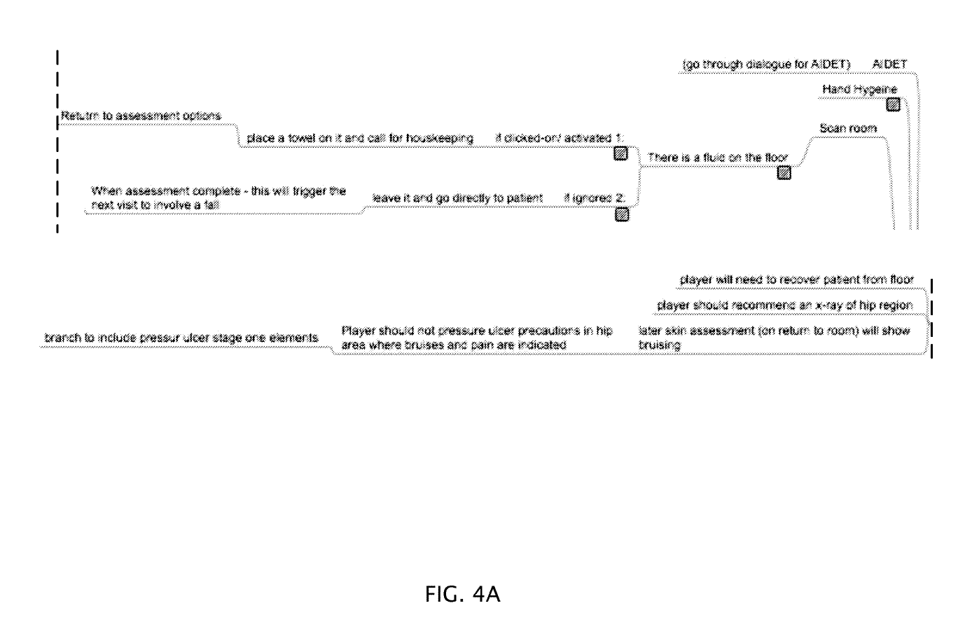

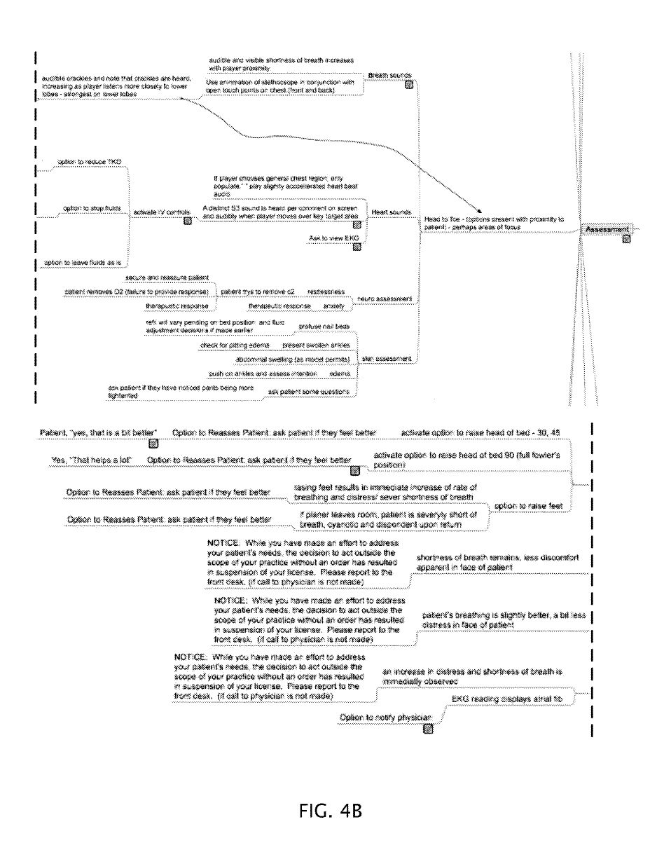

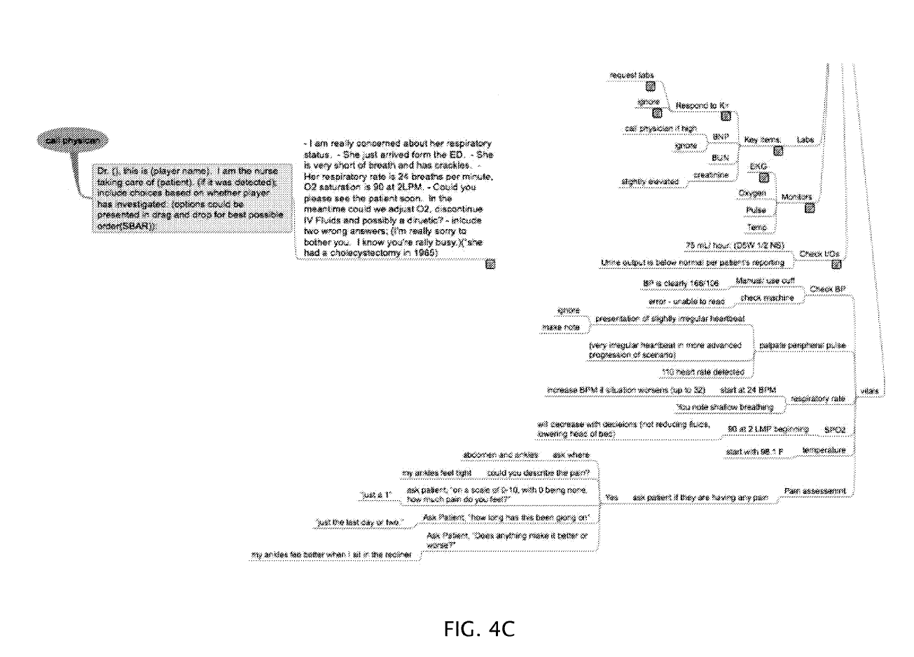

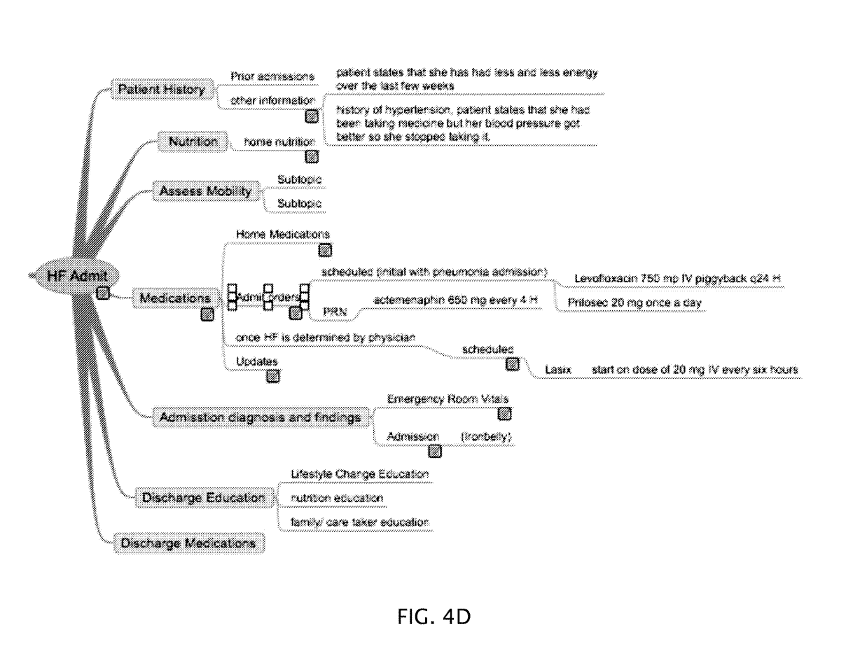

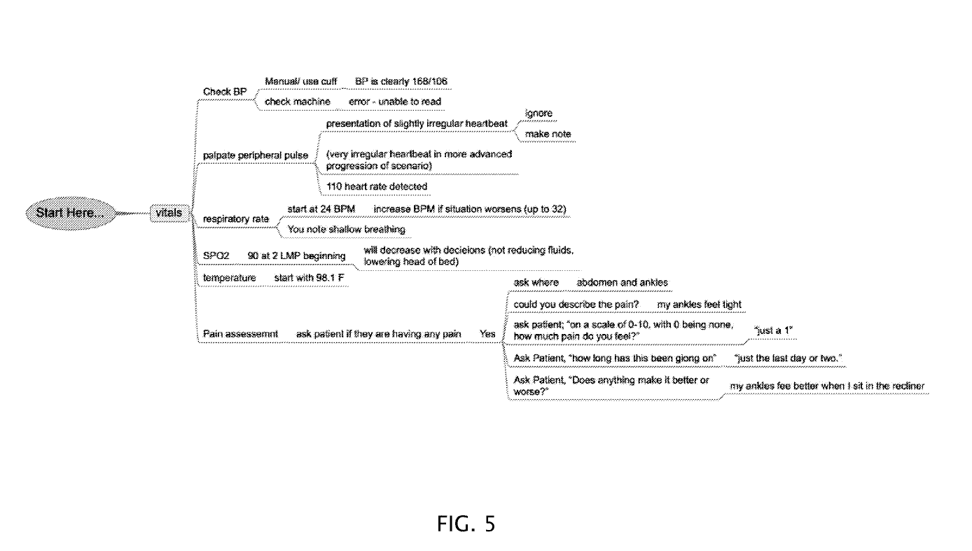

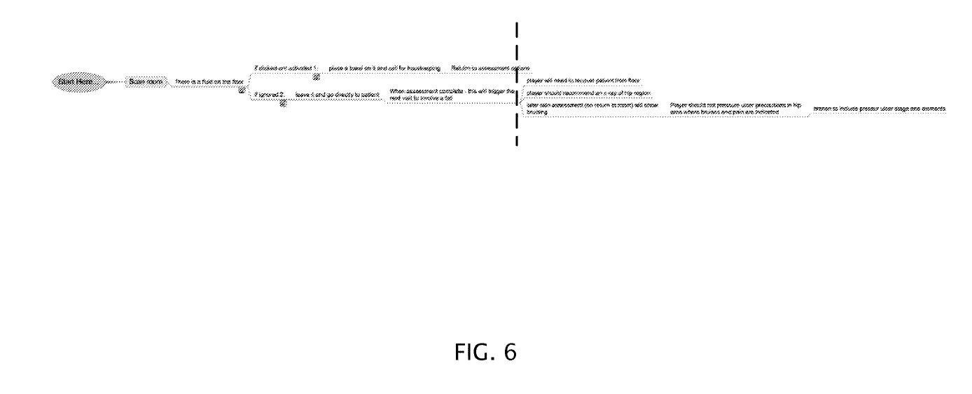

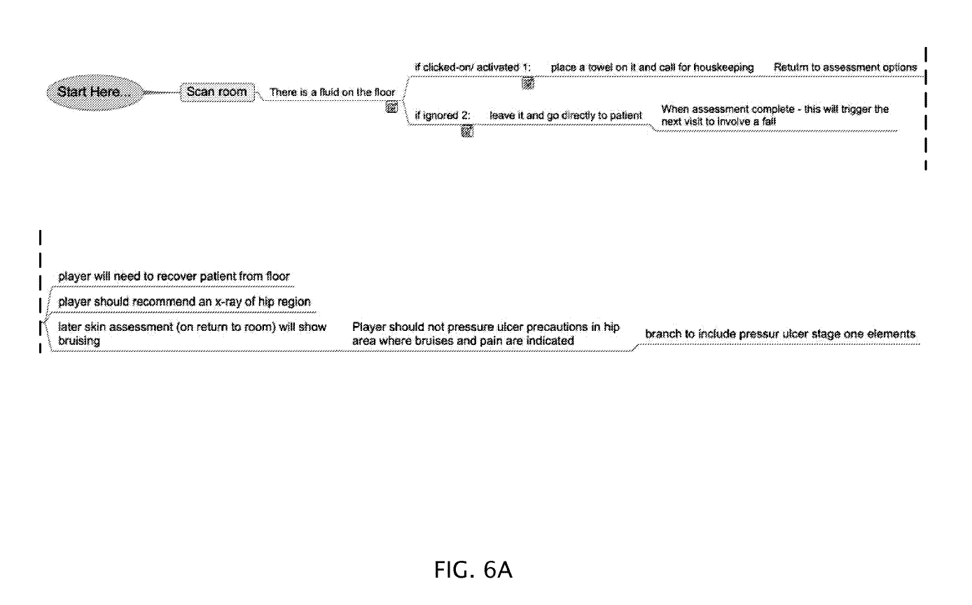

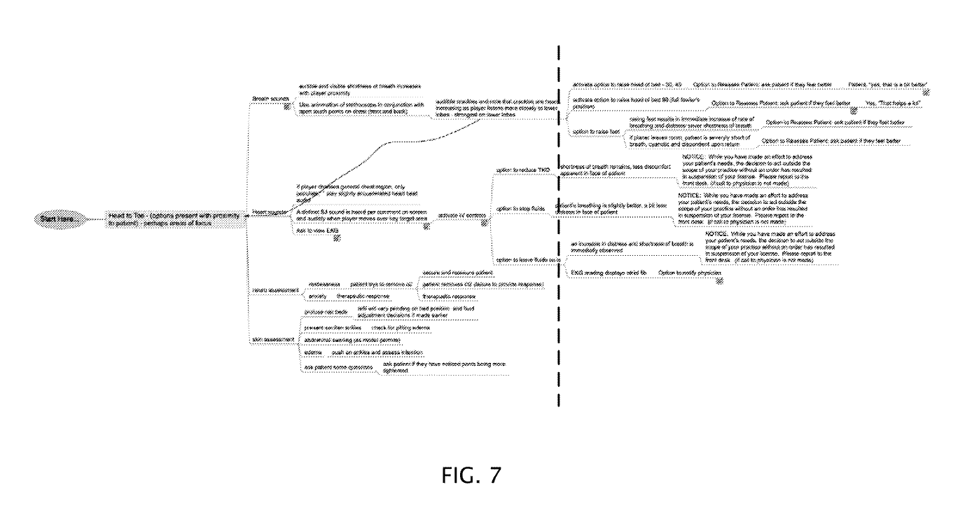

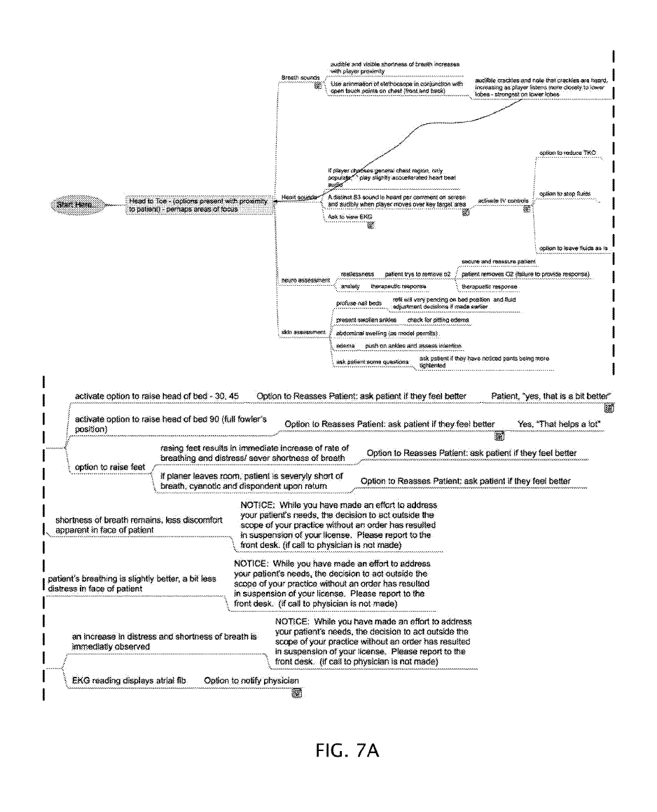

FIG. 4 (including FIGS. 4A-4D, which are enlarged portions of the flow diagram of FIG. 4), depicts a flow diagram of examples of assessments and user responses/selections that can be presented in a scenario of the present virtual learning environments. Such assessments and user responses/selections are explained in detailed in the figures; however, by way of example, and not limitation, a portion of the flow diagram of FIG. 4 is explained below. For example, as depicted in FIG. 4, one assessment in a first scenario may involve entering a scan room with fluid on the floor. A user can select (or activate) the fluid on the floor, or a user can ignore the fluid on the floor. If the fluid is selected, a user can choose to place a towel over the fluid and call for housekeeping, and the user is permitted to return to other assessments (e.g., breath sounds, heart sounds, neuro assessment, skin assessment, and the like). On the other hand, if the fluid on the floor is ignored, in a subsequent visit to the scan room (e.g., in a second scenario), the patient may have fallen because of the user's choice to ignore fluid on the floor. A user can select to recover the patient from the floor and, the virtual learning environment can be configured to reward a user if an X-ray of the patient is recommended (e.g., in the hip region). For example, if a user chooses to recommend an X-ray, a value corresponding to such a selection may be awarded to improve the user's score. On the other hand, if a user fails to recommend an X-ray, no value may be awarded or a negative value may be awarded. In a subsequent visit to the scan room (e.g., in a third scenario), if the user chooses to assess the patient's skin, the patient may be bruised from the fall. In such a subsequent visit (e.g., a third scenario), a user may be presented with one or more selections relating to various pressure ulcer precautions where bruises and pain are indicated. As depicted in FIG. 4D, prior to an assessment, a user may be provided with admit information relating to the patient, such as the patient history, nutrition, mobility, medications, admission diagnoses and findings, and the user further can provide discharge information for the patient, such as educational information and medications. Numerous other assessments, user responses/selections, and changes in subsequent scenarios, subsequent assessments, and subsequent user responses/selections based on prior user responses/selections are depicted in FIGS. 4-7A. User responses/selections may have predefined values corresponding to them, may have no value corresponding to them, and/or may have customizable values corresponding to them. Such values (if any) can be used to, for example, to derive a score (e.g., with an algorithm) and/or a competency level for a user, which can be based on a predefined or customizable standard of care, and which can be used to affect future scenarios.

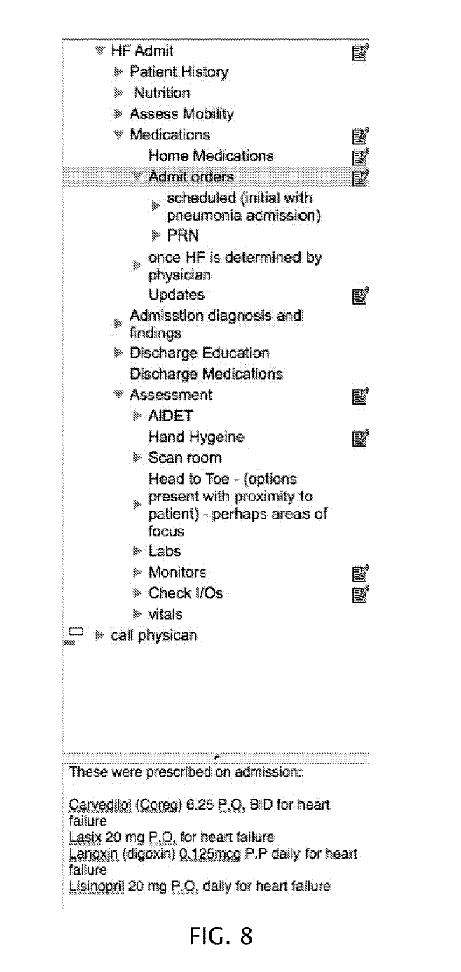

FIG. 8 depicts one example of a display of a portion of a scenario. Such a display can be editable, such as by the user and/or by an administrator, and can comprise information relating to the scenario, to the assessments, and/or to user responses/selections (both past and present).

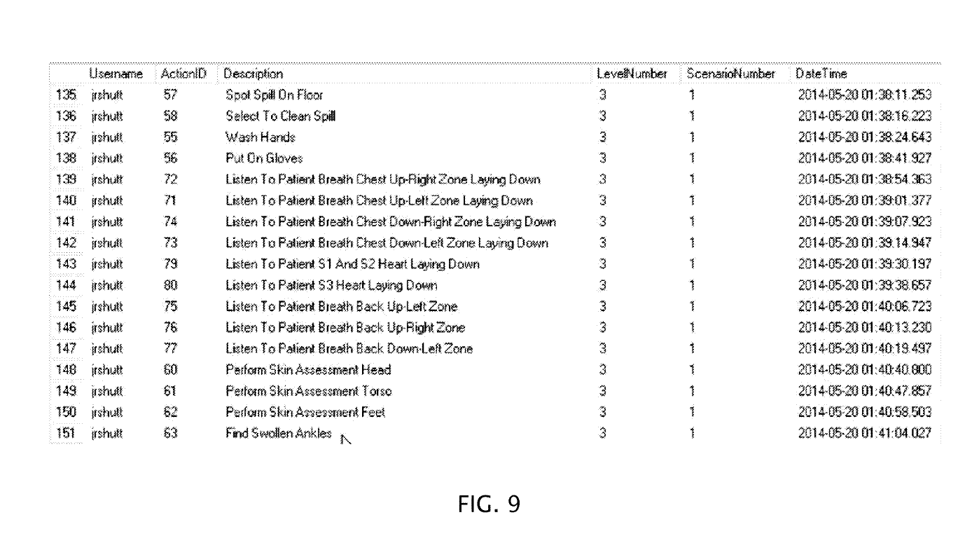

FIG. 9 depicts one example of a record that can be created based on a scenario of the present virtual learning environments. For example, as depicted in FIG. 9, a record can comprise information relating to the user, such as a username, user identification number, and the date and time of use, information relating to a scenario, such as the scenario number, information relating to a level (e.g., difficulty) of a scenario, such as a level number, information relating to an assessment and/or a user response/selection, such as an action identification number, and a description of the assessment and/or the user response/selection. Such a record can also include information relating to any value corresponding to a user response/selection (or any calculation involving such values) and any level of user competency that is determined.

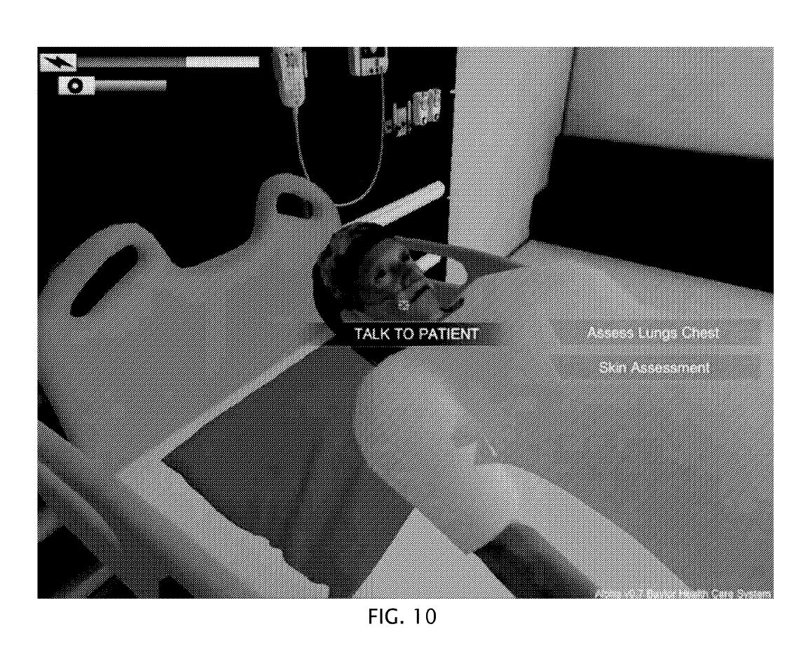

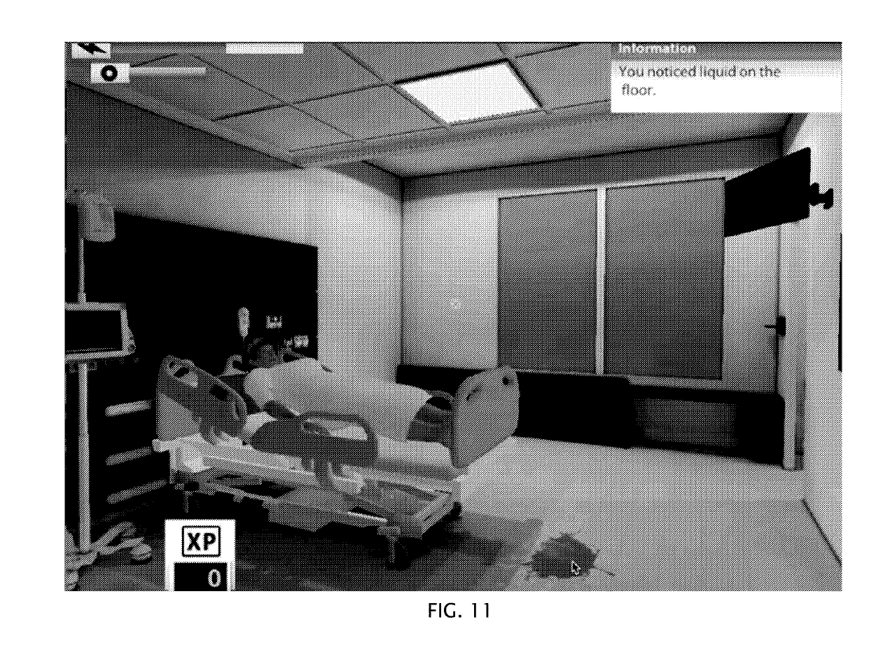

FIGS. 10-11 each depicts one example of a display of a portion of a scenario of the present virtual learning environments. For example, FIG. 10 depicts a patient lying in a bed. A user is presented with two assessments—a lung/chest assessment and a skin assessment—and the ability to make a user selection to talk to the patient. Any of the other portions of the display can be made selectable such that a user can be evaluated over that selectable portion of the display. As another example, FIG. 11 similarly depicts a patient lying in a bed. A fluid is depicted on the floor, and the fluid is selectable such that a user can choose to clean the fluid (e.g., which could prevent the patient from falling, as described above). Any value corresponding to a user selection (or sum of values corresponding to all user selections) can be displayed for the user. As with FIG. 10 and any other display of the present virtual learning environments, any of the portions of the display can be made selectable such that a user can be evaluated over that selectable portion of the display.

The use of the technology of this disclosure allows for the processing of information (e.g., data) that is not possible without the aid of such technology, or at least not at the speed achievable with such technology. Some embodiments of the performance of the disclosed functions may be achieved automatically or otherwise within a certain amount of time, such as an amount of time less than what it would take to perform the function or functions without the use of a computer system, processor, or processors, including, for example and depending on the embodiment, no more than one hour, no more than 30 minutes, no more than 15 minutes, no more than 10 minutes, no more than one minute, no more than one second, and no more than every time interval in seconds between one second and one hour.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present systems, storage media, and methods are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method of evaluating a user of a virtual learning environment comprising:
presenting a user with a first scenario in a virtual learning environment;
permitting the user to make one or more selections in response to a plurality of assessments in the first scenario;
identifying a value, if any, corresponding to the one or more user selections;
using at least one of the one or more user selections and the corresponding values, if any, to determine a second scenario;
presenting the user with the second scenario; and
permitting the user to make one or more selections in response to a plurality of assessments in the second scenario.

2. The method of claim 1, where the second scenario is determined in part by an algorithm.

3. The method of claim 2, where the input to the algorithm comprises the values corresponding to the one or more user selections, if any, and the output of the algorithm comprises one of a plurality of levels relating to user competency.

4. The method of claim 3, where the levels relating to user competency are based on a standard of care.

5. The method of claim 1, where using at least one of the one or more user selections and the corresponding values, if any, to determine a second scenario comprises summing the corresponding values to determine the second scenario.

6. The method of claim 1, where the plurality of assessments in the second scenario are substantially similar to the plurality of assessments in the first scenario.

7. The method of claim 6, where the values corresponding to the one or more user selections in the second scenario, if any, are different than the values corresponding to the one or more user selections in the first scenario, if any.

8. The method of claim 1, where the values corresponding to the one or more user selections, if any, are based on the user selection and the number of attempts to make the user selection.

9. The method of claim 6, where at least one of the one or more user selections in the second scenario is different than at least one of the one or more user selections in the first scenario.

10. The method of claim 1, further comprising:
permitting an administrator to manipulate at least a portion of the virtual learning environment.

11. The method of claim 10, where the administrator can manipulate a value corresponding to the one or more user selections, if any.

12. The method of claim 10, where the administrator can select the first scenario presented to the user.

13. The method of claim 10, where the administrator can customize the first scenario presented to the user.

14. The method of claim 1, further comprising:
preparing a report based on the one or more user selections.

15. The method of claim 14, where the report comprises information relating to at least one of the one or more user selections, information relating to a standard of care, and information relating to deviation of the one or more user selections from the standard of care.

16. The method of claim 1, where at least a portion of the first scenario changes based on the one or more user selections during the first scenario.

17. The method of claim 1, where the method further comprises:
presenting a lesson to the user relating to the first scenario.

18. A method of determining user competency in a virtual learning environment comprising:
presenting a user with a plurality of assessments in a first scenario in a virtual learning environment;
permitting the user to respond to each of the plurality of assessments;
identifying a value corresponding to each user response to the plurality of assessments, if any; and
determining, with an algorithm, a user competency level.

19. The method of claim 18, further comprising:
presenting a second scenario of a plurality of scenarios to the user based on the user competency level.

20. The method of claim 18, further comprising:
permitting the user to select from a plurality of user selections to respond to at least some of the plurality of assessments.

21. The method of claim 18, where each of the plurality of assessments are presented sequentially.

22. The method of claim 18, where a subsequent assessment in the plurality of assessments changes based on a user response to a prior assessment in the plurality of assessments.

23. The method of claim 18, where the input to the algorithm comprises the values corresponding to each user response to the plurality of assessments, if any, and the output of the algorithm comprises one of a plurality of levels relating to user competency.

24. The method of claim 23, where the levels relating to user competency are based on a standard of care.

25. The method of claim 18, where the algorithm includes summing the values corresponding to each user response to the plurality of assessments, if any.

26. The method of claim 19, where the second scenario comprises a plurality of assessments, and the plurality of assessments in the second scenario are substantially similar to the plurality of assessments in the first scenario.

27. The method of claim 19, where the values corresponding to each user response to the plurality of assessments in the second scenario, if any, are different than the values corresponding to each user response to the plurality of assessments in the first scenario, if any.

28. The method of claim 18, where the values corresponding to each user response to the plurality of assessments in the first scenario, if any, are based on the user response and the number of attempts to make the user response.

29. The method of claim 19, where the values corresponding to each user response to the plurality of assessments in the second scenario, if any, are based on the user response and the number of attempts to make the user response.

30. The method of claim 18, further comprising:
permitting an administrator to manipulate at least a portion of the virtual learning environment.

31. The method of claim 30, where the administrator can manipulate a value corresponding to each user response to the plurality of assessments, if any.

32. The method of claim 18, where the administrator can select the first scenario presented to the user.

33. The method of claim 18, where the administrator can customize the first scenario presented to the user.

34. The method of claim 18, further comprising:
preparing a report based on the user responses to the plurality of assessments.

35. The method of claim 34, where the report comprises information relating to at least one of the user responses, information relating to a standard of care, and information relating to deviation of the user responses from the standard of care.

36. The method of claim 18, where at least a portion of the first scenario changes based on the user responses to the plurality of assessments during the first scenario.

37. The method of claim 18, where the method further comprises:
presenting a lesson to the user relating to the first scenario.

38. A system comprising:
one or more processors; and
one or more non-transitory machine-readable storage media with instructions executable by the one or more processors and configured to cause the one or more processors to:
present a user with a first scenario in a virtual learning environment;
permit the user to make one or more selections in response to a plurality of assessments in the first scenario;
identify a value, if any, corresponding to the one or more user selections;
use at least one of the one or more user selections and the corresponding values, if any, to determine a second scenario;
present the user with the second scenario; and
permit the user to make one or more selections in response to a plurality of assessments in the second scenario.

39. The system of claim 38, where the second scenario is determined in part by an algorithm.

40. The system of claim 39, where the input to the algorithm comprises the values corresponding to the one or more user selections, if any, and the output of the algorithm comprises one of a plurality of levels relating to user competency.

41. The system of claim 40, where the levels relating to user competency are based on a standard of care.

42. The system of claim 38, where to use at least one of the one or more user selections and the corresponding values, if any, to determine a second scenario comprises summing the corresponding values to determine the second scenario.

43. The system of claim 38, where the plurality of assessments in the second scenario are substantially similar to the plurality of assessments in the first scenario.

44. The system of claim 43, where the values corresponding to the one or more user selections in the second scenario, if any, are different than the values corresponding to the one or more user selections in the first scenario, if any.

45. The system of claim 38, where the values corresponding to the one or more user selections, if any, are based on the user selection and the number of attempts to make the user selection.

46. The system of claim 43, where at least one of the one or more user selections in the second scenario is different than at least one of the one or more user selections in the first scenario.

47. The system of claim 38, where the one or more non-transitory machine-readable storage media are further configured to cause the one or more processors to:
permit an administrator to manipulate at least a portion of the virtual learning environment.

48. The system of claim 47, where the administrator can manipulate a value corresponding to the one or more user selections, if any.

49. The system of claim 47, where the administrator can select the first scenario presented to the user.

50. The system of claim 47, where the administrator can customize the first scenario presented to the user.

51. The system of claim 38, where the one or more non-transitory machine-readable storage media are further configured to cause the one or more processors to:
prepare a report based on the one or more user selections.

52. The system of claim 51, where the report comprises information relating to at least one of the one or more user selections, information relating to a standard of care, and information relating to deviation of the one or more user selections from the standard of care.

53. The system of claim 38, where at least a portion of the first scenario changes based on the one or more user selections during the first scenario.

54. The system of claim 38, where the one or more non-transitory machine-readable storage media are further configured to cause the one or more processors to:
present a lesson to the user relating to the first scenario.

55. A system comprising:
one or more processors; and
one or more non-transitory machine-readable storage media with instructions executable by the one or more processors and configured to cause the one or more processors to:
present a user with a plurality of assessments in a first scenario in a virtual learning environment;
permit the user to respond to each of the plurality of assessments;
identify a value corresponding to each user response to the plurality of assessments, if any; and
determine, with an algorithm, a user competency level.

56. The system of claim 55, where the one or more non-transitory machine-readable storage media are further configured to cause the one or more processors to:
present a second scenario of a plurality of scenarios to the user based on the user competency level.

57. The system of claim 55, where the one or more non-transitory machine-readable storage media are further configured to cause the one or more processors to:
permit the user to select from a plurality of user selections to respond to at least some of the plurality of assessments.

58. The system of claim 55, where each of the plurality of assessments are presented sequentially.

59. The system of claim 55, where a subsequent assessment in the plurality of assessments changes based on a user response to a prior assessment in the plurality of assessments.

60. The system of claim 55, where the input to the algorithm comprises the values corresponding to each user response to the plurality of assessments, if any, and the output of the algorithm comprises one of a plurality of levels relating to user competency.

61. The system of claim 60, where the levels relating to user competency are based on a standard of care.

62. The system of claim 55, where the algorithm includes summing the values corresponding to each user response to the plurality of assessments, if any.

63. The system of claim 56, where the second scenario comprises a plurality of assessments, and the plurality of assessments in the second scenario are substantially similar to the plurality of assessments in the first scenario.

64. The system of claim 56, where the values corresponding to each user response to the plurality of assessments in the second scenario, if any, are different than the values corresponding to each user response to the plurality of assessments in the first scenario, if any.

65. The system of claim 55, where the values corresponding to each user response to the plurality of assessments in the first scenario, if any, are based on the user response and the number of attempts to make the user response.

66. The system of claim 56, where the values corresponding to each user response to the plurality of assessments in the second scenario, if any, are based on the user response and the number of attempts to make the user response.

67. The system of claim 55, where the one or more non-transitory machine-readable storage media are further configured to cause the one or more processors to:
permit an administrator to manipulate at least a portion of the virtual learning environment.

68. The system of claim 67, where the administrator can manipulate a value corresponding to each user response to the plurality of assessments, if any.

69. The system of claim 55, where the administrator can select the first scenario presented to the user.

70. The system of claim 55, where the administrator can customize the first scenario presented to the user.

71. The system of claim 55, where the one or more non-transitory machine-readable storage media are further configured to cause the one or more processors to:
prepare a report based on the user responses to the plurality of assessments.

72. The system of claim 71, where the report comprises information relating to at least one of the user responses, information relating to a standard of care, and information relating to deviation of the user responses from the standard of care.

73. The system of claim 55, where at least a portion of the first scenario changes based on the user responses to the plurality of assessments during the first scenario.

74. The system of claim 55, where the one or more non-transitory machine-readable storage media are further configured to cause the one or more processors to:
present a lesson to the user relating to the first scenario.

75. A non-transitory machine-readable storage medium with instructions executable by a processor of a computing device, the non-transitory machine-readable storage medium comprising:
instructions for presenting a user with a first scenario in a virtual learning environment;
instructions for permitting the user to make one or more selections in response to a plurality of assessments in the first scenario;
instructions for identifying a value, if any, corresponding to the one or more user selections;
instructions for using at least one of the one or more user selections and the corresponding values, if any, to determine a second scenario;
instructions for presenting the user with the second scenario; and
instructions for permitting the user to make one or more selections in response to a plurality of assessments in the second scenario.

76. The storage medium of claim 75, where the second scenario is determined in part by an algorithm.

77. The storage medium of claim 76, where the input to the algorithm comprises the values corresponding to the one or more user selections, if any, and the output of the algorithm comprises one of a plurality of levels relating to user competency.

78. The storage medium of claim 77, where the levels relating to user competency are based on a standard of care.

79. The storage medium of claim 75, where the instructions for using at least one of the one or more user selections and the corresponding values, if any, to determine a second scenario comprises summing the corresponding values to determine the second scenario.

80. The storage medium of claim 75, where the plurality of assessments in the second scenario are substantially similar to the plurality of assessments in the first scenario.

81. The storage medium of claim 80, where the values corresponding to the one or more user selections in the second scenario, if any, are different than the values corresponding to the one or more user selections in the first scenario, if any.

82. The storage medium of claim 75, where the values corresponding to the one or more user selections, if any, are based on the user selection and the number of attempts to make the user selection.

83. The storage medium of claim 80, where at least one of the one or more user selections in the second scenario is different than at least one of the one or more user selections in the first scenario.

84. The storage medium of claim 75, further comprising:
instructions for permitting an administrator to manipulate at least a portion of the virtual learning environment.

85. The storage medium of claim 84, where the administrator can manipulate a value corresponding to the one or more user selections, if any.

86. The storage medium of claim 84, where the administrator can select the first scenario presented to the user.

87. The storage medium of claim 84, where the administrator can customize the first scenario presented to the user.

88. The storage medium of claim 75, further comprising:
instructions for preparing a report based on the one or more user selections.

89. The storage medium of claim 88, where the report comprises information relating to at least one of the one or more user selections, information relating to a standard of care, and information relating to deviation of the one or more user selections from the standard of care.

90. The storage medium of claim 75, where at least a portion of the first scenario changes based on the one or more user selections during the first scenario.

91. The storage medium of claim 75, further comprising:
instructions for presenting a lesson to the user relating to the first scenario.

92. A non-transitory machine-readable storage medium with instructions executable by a processor of a computing device, the non-transitory machine-readable storage medium comprising:
instructions for presenting a user with a plurality of assessments in a first scenario in a virtual learning environment;
instructions for permitting the user to respond to each of the plurality of assessments;
instructions for identifying a value corresponding to each user response to the plurality of assessments, if any; and
instructions for determining, with an algorithm, a user competency level.

93. The storage medium of claim 92, where the storage medium further comprises:
instructions for presenting a second scenario of a plurality of scenarios to the user based on the user competency level.

94. The storage medium of claim 92, where the storage medium further comprises:
instructions for permitting the user to select from a plurality of user selections to respond to at least some of the plurality of assessments.

95. The storage medium of claim 92, where each of the plurality of assessments are presented sequentially.

96. The storage medium of claim 92, where a subsequent assessment in the plurality of assessments changes based on a user response to a prior assessment in the plurality of assessments.

97. The storage medium of claim 92, where the input to the algorithm comprises the values corresponding to each user response to the plurality of assessments, if any, and the output of the algorithm comprises one of a plurality of levels relating to user competency.

98. The storage medium of claim 97, where the levels relating to user competency are based on a standard of care.

99. The storage medium of claim 92, where the algorithm includes summing the values corresponding to each user response to the plurality of assessments, if any.

100. The storage medium of claim 93, where the second scenario comprises a plurality of assessments, and the plurality of assessments in the second scenario are substantially similar to the plurality of assessments in the first scenario.

101. The storage medium of claim 93, where the values corresponding to each user response to the plurality of assessments in the second scenario, if any, are different than the values corresponding to each user response to the plurality of assessments in the first scenario, if any.

102. The storage medium of claim 92, where the values corresponding to each user response to the plurality of assessments in the first scenario, if any, are based on the user response and the number of attempts to make the user response.

103. The storage medium of claim 93, where the values corresponding to each user response to the plurality of assessments in the second scenario, if any, are based on the user response and the number of attempts to make the user response.

104. The storage medium of claim 92, where the storage medium further comprises:
instructions for permitting an administrator to manipulate at least a portion of the virtual learning environment.

105. The storage medium of claim 104, where the administrator can manipulate a value corresponding to each user response to the plurality of assessments, if any.

106. The storage medium of claim 92, where the administrator can select the first scenario presented to the user.

107. The storage medium of claim 92, where the administrator can customize the first scenario presented to the user.

108. The storage medium of claim 92, where the storage medium further comprises:
instructions for preparing a report based on the user responses to the plurality of assessments.

109. The storage medium of claim 108, where the report comprises information relating to at least one of the user responses, information relating to a standard of care, and information relating to deviation of the user responses from the standard of care.

110. The storage medium of claim 92, where at least a portion of the first scenario changes based on the user responses to the plurality of assessments during the first scenario.

111. The storage medium of claim 92, where the storage medium further comprises:
instructions for presenting a lesson to the user relating to the first scenario.
